(19) United States
(12) Patent Application Publication
(10) Pub. No.: US 2021/0095150 A1
(43) Pub. Date: Apr. 1, 2021

(54) INK JET RECORDING APPARATUS, INK JET RECORDING METHOD, AND AQUEOUS INK COMPOSITION

(71) Applicant: Seiko Epson Corporation, Tokyo (JP)

(72) Inventors: Yusuke MIZUTAKI, Shiojiri (JP); Kiyomi KUMAMOTO, Shiojiri (JP); Tomohiro ARUGA, Matsumoto (JP); Jun ITO, Shimosuwa (JP); Tomoki MARUYAMA, Matsumoto (JP); Yasunori KOIKE, Matsumoto (JP)

(21) Appl. No.: 17/036,012

(22) Filed: Sep. 29, 2020

(30) Foreign Application Priority Data
Sep. 30, 2019 (JP) 2019-179756

(51) Int. Cl. C09D 11/328; B41J 2/175; C09D 11/40

(52) U.S. Cl. CPC C09D 11/328; C09D 11/40; B41J 2/17503

(57) ABSTRACT

An ink jet recording apparatus includes at least one aqueous ink composition, at least one ink encasement in which the aqueous ink composition is encased, a recording head that ejects the aqueous ink composition, and a carriage configured to move the ink encasement and the recording head back and forth. The carriage carries the ink encasement, with the ink encasement integrated with the carriage. The ink encasement has an ink fill port that opens and shuts as a port through which the aqueous ink composition is loaded, and the maximum external length of the ink encasement in the direction parallel with the direction in which the carriage moves back and forth is 30.0 mm or less.

The present application is based on, and claims priority from JP Application Serial Number 2019-179756, filed Sep. 30, 2019, the disclosure of which is hereby incorporated by reference herein in its entirety.

### BACKGROUND

### 1. Technical Field

The present disclosure relates to an ink jet recording apparatus, an ink jet recording method, and an aqueous ink composition.

### 2. Related Art

In the field of relatively small ink jet recording apparatuses, such as those for household and office use, there is a demand for increasing the capacity of an ink encasement from which ink is supplied to a recording head and for reducing the overall body size.

Known serial ink jet recording apparatuses use a cartridge, which is of small capacity, or an ink tank, which provides a larger capacity, as a container from which an ink composition is supplied to a recording head. A cartridge is a container that is mounted on a carriage (mechanism that moves a recording head back and forth) together with a recording head, and the user can detach the cartridge from the carriage and attach it again. Cartridges, however, require frequent replacement because of their small capacity.

To address this, JP-A-2019-019220, for example, proposes a large-capacity ink tank. Increasing the capacity of an ink tank helps reduce the frequency of replacement and refilling.

A large ink tank, however, is difficult to mount on a carriage. Instead, it supplies the ink composition therein to a recording head through a tube or similar pathway. An on-carriage ink tank can therefore be a way to combine a large ink capacity and a compact size.

An ink encasement larger than known cartridges and smaller than known ink tanks, for example, can be mounted on a carriage together with a recording head. The amount of ink composition encased in the ink encasement is not too small, and the influence on the size of the apparatus is less significant.

Replenishing or filling such an ink encasement mounted on a carriage with an ink composition, however, can cause bubbles to form inside the ink encasement. The aqueous ink composition in the ink encasement can also foam when it is rocked by the movement of the carriage. The shape of the ink encasement can also influence how violently the ink composition therein is rocked and therefore the likelihood of foaming. Bubbles that come close to nozzles can cause unstable continuous printing. The off-carriage configuration may help prevent foaming but occasionally can cause mottling to the resulting recording.

### SUMMARY

A form of an ink jet recording apparatus according to an aspect of the present disclosure includes at least one aqueous ink composition, at least one ink encasement in which the aqueous ink composition is encased, a recording head that ejects the aqueous ink composition, and a carriage configured to move the ink encasement and the recording head back and forth. The carriage carries the ink encasement, with the ink encasement integrated with the carriage. The ink encasement has an ink fill port that opens and shuts as a port through which the aqueous ink composition is loaded, and a maximum external length of the ink encasement in a direction parallel with a direction in which the carriage moves back and forth is 30.0 mm or less.

In the above form of an ink jet recording apparatus, a minimum thickness of walls of the ink encasement perpendicular to the direction parallel with the direction in which the carriage moves back and forth may be 0.1 mm or more and 5.0 mm or less.

In any of the above forms of ink jet recording apparatuses, the maximum external length of the ink encasement in the direction parallel with the direction in which the carriage moves back and forth may be 10.0 mm or more.

In any of the above forms of ink jet recording apparatuses, a gas-to-liquid ratio by volume, gas/liquid, inside the ink encasement may be 3/16 or more.

In any of the above forms of ink jet recording apparatuses, a gas-to-liquid ratio by volume, gas/liquid, inside the ink encasement may be 16/3 or less.

In any of the above forms of ink jet recording apparatuses, an angle of contact of the aqueous ink composition with an inner wall of the ink encasement may be 40° or less.

In any of the above forms of ink jet recording apparatuses, the aqueous ink composition may contain a dye or pigment.

In any of the above forms of ink jet recording apparatuses, the at least one ink encasement carried on the carriage may be a plurality of ink encasements, and the recording head may eject each of the ink compositions encased in the ink encasements.

A form of an ink jet recording method according to an aspect of the present disclosure is a recording method in which an ink jet recording apparatus is used that includes an aqueous ink composition, an ink encasement in which the aqueous ink composition is encased, a recording head that ejects the aqueous ink composition, and a carriage configured to move the recording head back and forth. The carriage carries the ink encasement, with the ink encasement integrated with the carriage. The ink encasement has an ink fill port that opens and shuts as a port through which the aqueous ink composition is loaded, and a maximum external length of the ink encasement in a direction parallel with a direction in which the carriage moves back and forth is 30.0 mm or less. The method includes ejecting the aqueous ink composition from the recording head to attach the aqueous ink composition to a recording medium.

A form of an aqueous ink composition according to an aspect of the present disclosure is for use with an ink jet recording apparatus that includes the aqueous ink composition, an ink encasement in which the aqueous ink composition is encased, a recording head that ejects the aqueous ink composition, and a carriage configured to move the recording head back and forth. The carriage carries the ink encasement, with the ink encasement integrated with the carriage. The ink encasement has an ink fill port that opens and shuts as a port through which the aqueous ink composition is loaded, and a maximum external length of the ink encasement in a direction parallel with a direction in which the carriage moves back and forth is 30.0 mm or less.

### BRIEF DESCRIPTION OF THE DRAWINGS

FIG. 1 is an outline perspective diagram illustrating an example of an ink jet recording apparatus according to an embodiment.

FIG. 2 is a perspective diagram schematically illustrating an ink encasement according to an embodiment.

### DESCRIPTION OF EXEMPLARY EMBODIMENTS

The following describes embodiments of the present disclosure. The following embodiments are descriptions of examples of the disclosure. The disclosure is never limited to these embodiments and includes variations implemented within the gist of the disclosure. Not all the configurations described below are essential for the disclosure.

### 1. INK JET RECORDING APPARATUS

An ink jet recording apparatus according to this embodiment includes an aqueous ink composition, an ink encasement in which the aqueous ink composition is encased, a recording head that ejects the aqueous ink composition, and a carriage configured to move the recording head back and forth.

### 1.1. Aqueous Ink Composition

As a component of the ink jet recording apparatus according to this embodiment, the aqueous ink composition may contain water, a colorant, a surfactant, an organic solvent, and other ingredients.

### 1.1.1. Water

The aqueous ink composition according to this embodiment may contain water. For example, the water can be of a type from which ionic impurities have been removed to the lowest possible levels, such as deionized water, ultrafiltered water, reverse osmosis water, distilled water, or any other type of purified or ultrapure water. The use of sterilized water, for example sterilized by ultraviolet irradiation or adding hydrogen peroxide, helps control the development of bacteria and fungi when the aqueous ink composition is stored long.

Preferably, the water content is 40% by mass or more, more preferably 45% by mass or more, even more preferably 50% by mass or more of the total amount (100% by mass) of the aqueous ink composition. A water content of 40% by mass or more makes the aqueous ink composition of relatively low viscosity. As for the upper limit, the water content is preferably 90% by mass or less, more preferably 85% by mass or less, even more preferably 80% by mass or less of the total amount of the aqueous ink composition.

### 1.1.2. Colorant

The aqueous ink composition may contain a colorant. Colorants make the aqueous ink composition colored. A colored ink composition is used to color a recording medium. Pigment(s), dye(s), or both can be used.

### Pigments

The use of a pigment as a colorant helps improve the light fastness of the aqueous ink composition. Both inorganic and organic pigments can be used. Examples include process color pigments, such as cyan, yellow, magenta, and black pigments, and spot color pigments, such as white and glitter pigments.

Examples of organic pigments include quinacridone pigments, quinacridone quinone pigments, dioxane pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, thioindigo pigments, isoindolinone pigments, azomethine pigments, dye chelates, dyeing lakes, nitro pigments, nitroso pigments, aniline black, and azo pigments, such as insoluble azo pigments, condensed azo pigments, azo lakes, and chelate azo pigments.

Specific examples of organic pigments include the following.

Examples of cyan pigments include C.I. Pigment Blue 1, 2, 3, 15:3, 15:4, 16, 22, and 60 and C.I. Vat Blue 4 and 60. One or a mixture of two or more selected from the group consisting of C.I. Pigment Blue 15:3, 15:4, and 60 is preferred.

Examples of magenta pigments include C.I. Pigment Red 5, 7, 12, 48 (Ca), 48 (Mn), 57 (Ca), 57:1, 112, 122, 123, 168, 184, and 202 and C.I. Pigment Violet 19. One or a mixture of two or more selected from the group consisting of C.I. Pigment Red 122, 202, and 209 and C.I. Pigment Violet 19 is preferred.

Examples of yellow pigments include C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, and 185. One or a mixture of two or more selected from the group consisting of C.I. Pigment Yellow 74, 109, 110, 128, and 138 is preferred.

An orange pigment can be C.I. Pigment Orange 36 or 43. A mixture of them can also be used.

A green pigments can be C.I. Pigment Green 7 or 36. A mixture of them can also be used.

Examples of black pigments include furnace black, lamp black, acetylene black, and channel black (C.I. Pigment Black 7 pigments). Examples of commercially available ones include No. 2300, 900, MCF88, No. 20B, No. 33, No. 40, No. 45, No. 52, MA7, MA8, MA100, and No. 2200B (trade names, Mitsubishi Chemical Corporation), Color Black FW1, FW2, FW2V, FW18, FW200, 5150, 5160, and 5170, Printex 35, U, V, and 140U, and Special Black 6, 5, 4A, 4, and 250 (trade names, Degussa), Conductex SC and Raven 1255, 5750, 5250, 5000, 3500, 1255, and 700 (all are trade names, Columbian Carbon), and REGAL 400R, 330R, and 660R, MOGUL L, MONARCH 700, 800, 880, 900, 1000, 1100, 1300, and 1400, and ELFTEX 12 (trade names, Cabot). One or a mixture of two or more of such carbon black pigments may be used.

A glitter pigment can be any kind of pigment that can glitter on a medium. Examples include metal particles, which are particles of one, or an alloy of two or more, selected from the group consisting of aluminum, silver, gold, platinum, nickel, chromium, tin, zinc, indium, titanium, and copper (alloys also referred to as metallic pigments), and pearl pigments, which have a pearly gloss. Typical examples of pearl pigments include pigments having a pearlescent or interference gloss, such as titanium dioxide-coated mica, pearl essence, and bismuth oxychloride. Glitter pigments that have been surface-treated to be inert with water can also be used.

Examples of white pigments include metal compounds, such as metal oxides, barium sulfate, and calcium carbonate. Examples of metal oxides include titanium dioxide, zinc oxide, silica, alumina, and magnesium oxide. Hollow particles can also be used as a white pigment.

One such pigment alone or a combination of two or more may be used. Organic pigments are preferred in terms of storage stability characteristics, such as light fastness, weather resistance, and resistance to gases.

Pigments that reach stable dispersion in the ink are preferred. For example, a pigment may be rendered self-dispersible through a surface treatment of the pigment particles, such as surface oxidation or sulfonation, with ozone, hypochlorous acid, fuming sulfuric acid, etc. Alternatively, a polymeric dispersant may be used.

### Dyes

The aqueous ink composition may contain a dye as a colorant. The dye can be of any kind; acidic dyes, direct dyes, reactive dyes, basic dyes, and disperse dyes can be used. Examples include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 132, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, 141, and 249, and C.I. Reactive Black 3, 4, and 35.

Other examples include at least one selected from the compound represented by formula (y-1) below or its salt

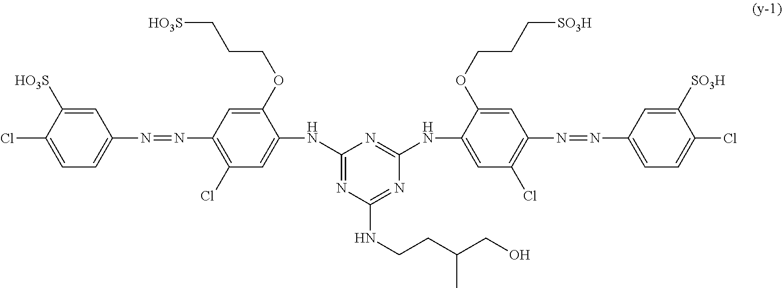 [SMILES: CC(CO)CCNc1nc(Nc2cc(Cl)c(N=Nc3ccc(Cl)c(S(=O)(=O)O)c3)cc2OCCCS(=O)(=O)O)nc(Nc2cc(Cl)c(N=Nc3ccc(Cl)c(S(=O)(=O)O)c3)cc2OCCCS(=O)(=O)O)n1]

(In formula (y-1), each of the four sulfonic acid groups may independently be in the sulfonate form. Examples of counterions in a salt of the compound represented by formula (y-1) include the hydrogen (proton), lithium, sodium, potassium, and ammonium ions, and the counterion may be of the same or different species between the four sulfonic acid groups.),

the compound represented by formula (y-2) below or its salt

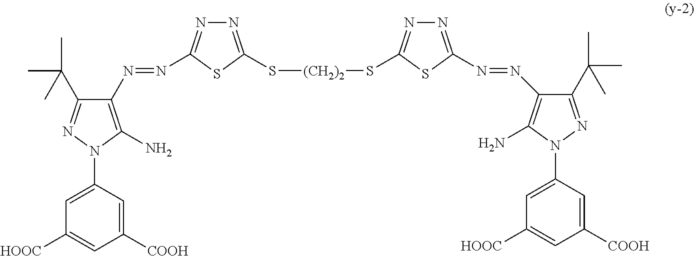

(In formula (y-2), each of the four carboxy groups may independently be in the carboxylate form. Examples of counterions in a salt of the compound represented by formula (y-2) include the hydrogen (proton), lithium, sodium, potassium, and ammonium ions, and the counterion may be of the same or different species between the four carboxy groups.),

the compound represented by formula (y-3) below or its salt

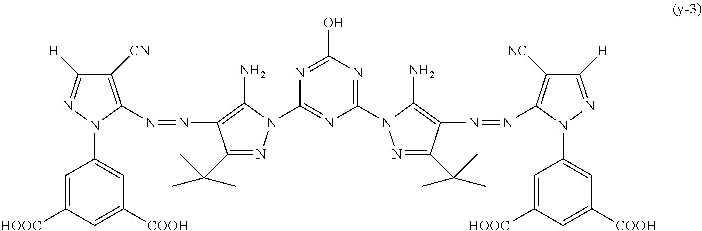 [SMILES: CC(C)(C)c1nn(-c2nc(O)nc(-n3nc(C(C)(C)C)c(N=Nc4c(C#N)cnn4-c4cc(C(=O)O)cc(C(=O)O)c4)c3N)n2)c(N)c1N=Nc1c(C#N)cnn1-c1cc(C(=O)O)cc(C(=O)O)c1]

(In formula (y-3), each of the four carboxy groups may independently be in the carboxylate form. Examples of counterions in a salt of the compound represented by formula (y-3) include the hydrogen (proton), lithium, sodium, potassium, and ammonium ions, and the counterion may be of the same or different species between the four carboxy groups.),

the compound represented by formula (y-4) below or its salt,

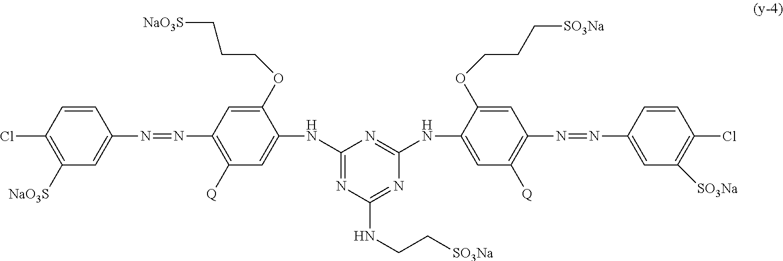

the compound represented by formula (y-5) below or its salt,

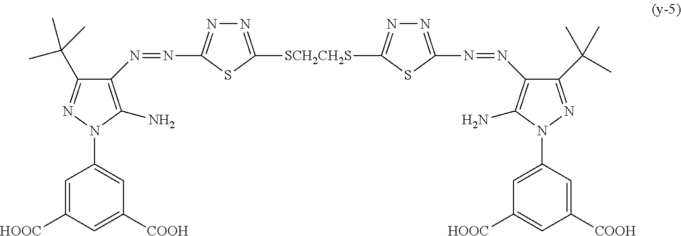

the compound represented by formula (m-1) below or its salt

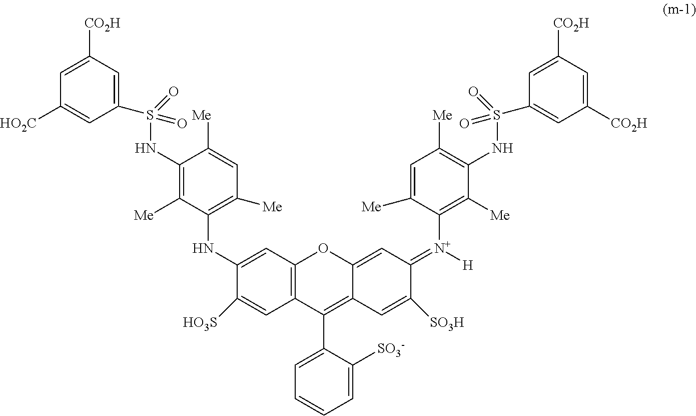

(Examples of counterions in a salt of the compound represented by formula (m-1) include the hydrogen (proton), lithium, sodium, potassium, and ammonium ions, and the counterion may be of the same or different species between the four carboxy and two sulfonic acid groups.),

the compound represented by formula (m-2) below or its salt

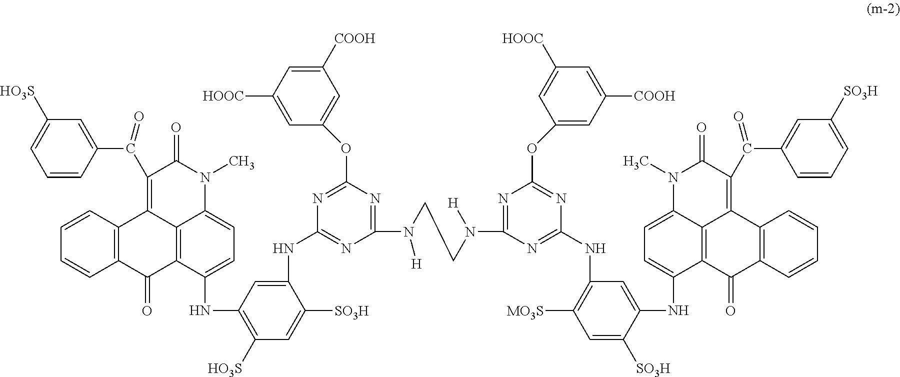

(Examples of counterions in a salt of the compound represented by formula (m-2) include the hydrogen (proton), lithium, sodium, potassium, and ammonium ions, and the counterion may be of the same or different species between the four carboxy and six sulfonic acid groups.),

a compound represented by formula (m-3) below or its salt

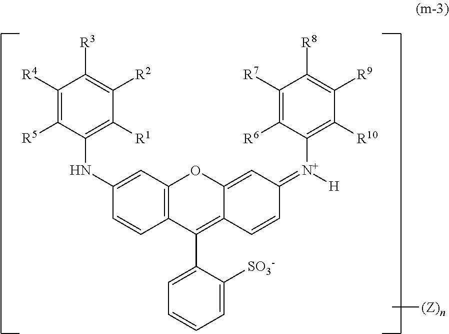

(In formula (m-3), R¹, R⁵, R⁶, and R¹⁰ each independently represent an alkyl group. R³ and R⁸ each independently represent a hydrogen atom or alkyl, alkoxy, or aryloxy group. An alkyl, alkoxy, or aryloxy group may have at least one type of substituent selected from the group of substituents consisting of the alkyl, aryl, arylalkyl, hydroxyl, carbamoyl, sulfamoyl, alkoxy, and cyano groups, halogens, and ionic groups. R², R⁴, R⁷, and R⁹ each independently represent a hydrogen atom or an acylamino group represented by formula (m-3′) below, with at least one of R², R⁴, R⁷, and R⁹ being an acylamino group represented by formula (m-3′) below. Z represents a SO₃H, SO₃M (where M represents an ammonium ion or alkali metal ion), or sulfamoyl group. represents an integer of 0 to 3 when at least one of R², R³, R⁴, R⁷, R⁸, and R⁹ is substituted with an ionic group, and an integer of 1 to 3 when not. Z, when present, is in place of at least one aromatic hydrogen atom.)

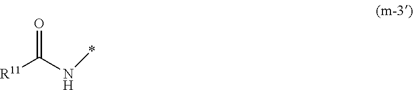

(In formula (m-3′), R¹¹ represents an alkyl, cycloalkyl, aryl, arylalkyl, alkenyl, or heterocyclic group. The alkyl, cycloalkyl, aryl, arylalkyl, alkenyl, or heterocyclic group may have at least one type of substituent selected from the group of substituents consisting of the alkyl, aryl, arylalkyl, alkenyl, alkoxy, cyano, alkylamino, sulfoalkyl, carbamoyl, sulfamoyl, and sulfonylamino groups, halogens, and ionic groups. represents a site for binding with the aromatic ring in formula (m-3).) (Examples of counterions in a salt of a compound represented by formula (m-3) include the hydrogen (proton), lithium, sodium, potassium, and ammonium ions.),

the compound represented by formula (m-4) below or its salt

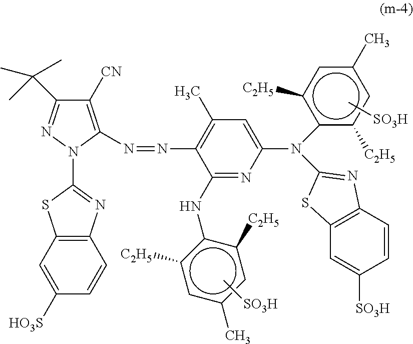

(Examples of counterions in a salt of the compound represented by formula (m-4) include the hydrogen (proton), lithium, sodium, potassium, and ammonium ions, and the counterion may be of the same or different species between the four sulfonic acid groups.),

a compound represented by formula (m-5) below or its salt

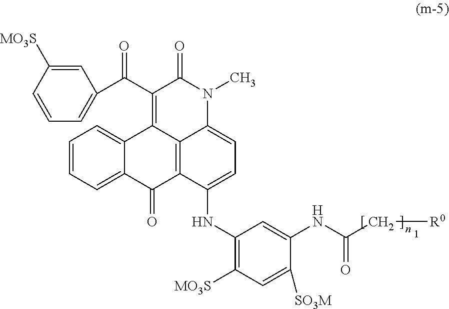

(In formula (m-5), n₁ is 1 or 2, each of the three Ms is sodium or ammonium, the three Ms may be the same or different, and R⁰ is a C1 to C8 monoalkylamino group substituted with a carboxy group.),

a compound represented by formula (c-1) below or its salt

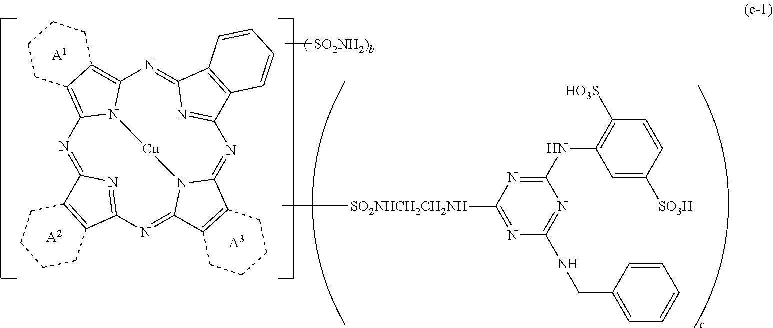

(In formula (c-1), 0≤b≤4, 0≤c'4, and 1≤(b+c)≤4, where b+c is an integer. Rings A¹, A², and A³ are each selected from the benzene, 2,3-pyridine, and 3,2-pyridine rings, with at least one of rings A¹, A², and A³ being a 2,3-pyridine or 3,2-pyridine ring. Rings A¹, A², and A³ may be the same or different.) (Examples of counterions in a salt of a compound represented by formula (c-1) include the hydrogen (proton), lithium, sodium, potassium, and ammonium ions, and the counterion may be of the same or different species between the sulfonic acid groups.),

the compound represented by formula (c-2) below or its salt

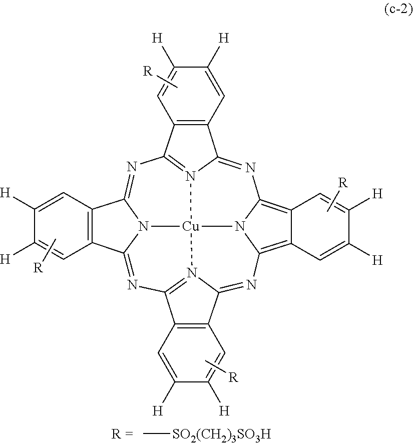

(Examples of counterions in a salt of the compound represented by formula (c-2) include the hydrogen (proton), lithium, sodium, potassium, and ammonium ions, and the counterion may be of the same or different species between the four sulfonic groups.),

the compound represented by formula (c-3) below or its salt

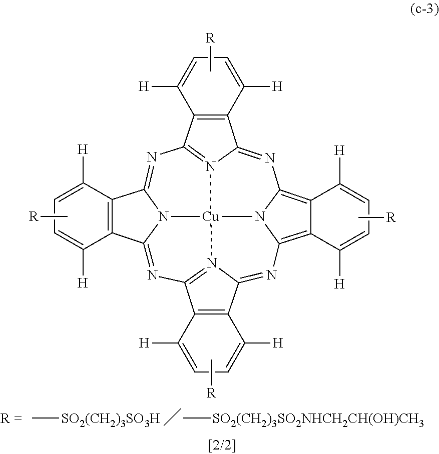

(Examples of counterions in a salt of the compound represented by formula (c-3) include the hydrogen (proton), lithium, sodium, potassium, and ammonium ions, and the counterion may be of the same or different species between the two sulfonic acid groups.),

a compound represented by formula (c-4) below or its salt

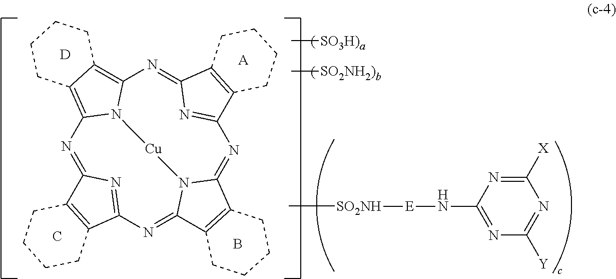

(In formula (c-4), each of rings A, B, C, and D is independently an aromatic six-membered ring, with at least one of rings A, B, C, and D being a pyridine or pyrazine ring. E is an alkylene group. X is a sulfo-, carboxy-, or phosphono-substituted anilino group that may further have one to four substituents of type(s) selected from the group consisting of the sulfonic acid, carboxy, phosphono, sulfamoyl, carbamoyl, hydroxy, alkoxy, amino, alkylamino, dialkylamino, arylamino, diarylamino, acetylamino, ureido, alkyl, nitro, and cyano groups, halogens, and alkylsulfonyl and alkylthio groups. Y is a hydroxy or amino group. 1.0≤a≤2.0, 0.0≤b≤3.0, 0.1≤c≤3.0, and 1.0≤a+b+c≤4.0.) (Examples of counterions in a salt of a compound represented by formula (c-4) include the hydrogen (proton), lithium, sodium, potassium, and ammonium ions.),

the compound represented by formula (c-5) below or its salt

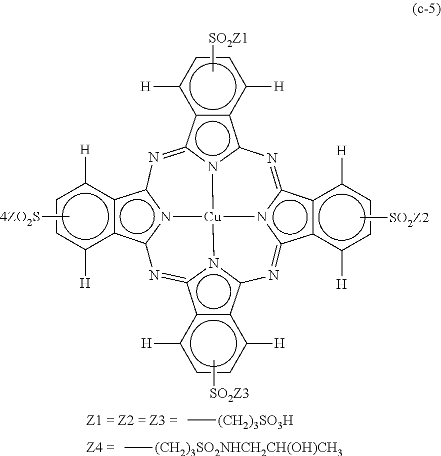

(Examples of counterions in a salt of the compound represented by formula (c-5) include the hydrogen (proton), lithium, sodium, potassium, and ammonium ions, and the counterion may be of the same or different species between the three sulfonic acid groups.), and

a compound represented by formula (c-6) or its salt

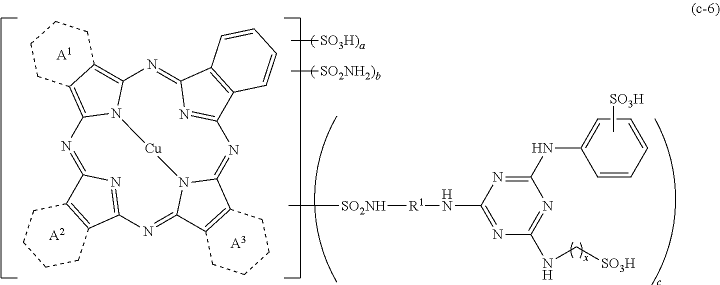

(In formula (c-6) , rings A¹, A², and A³ are each selected from the benzene, 2,3-pyridine, and 3,2-pyridine rings, with at least one of rings A¹, A², and A³ being a 2,3-pyridine or 3,2-pyridine ring, and rings A¹, A², and A³ may be the same or different. 1.0≤a≤3.0, 0.2≤b≤1.8, 0.8≤c≤1.6, and 0≤a+b+c<4. 1≤x≤3, where x is an integer. R¹ is a C1 to C6 linear alkylene group.).

One such colorant, whether a pigment or a dye, may be used alone, or two or more may be used in combination.

Preferably, the total colorant content is 1% by mass or more and 20% by mass or less of the total mass (100% by mass) of the aqueous ink composition. The aqueous ink composition may be a clear composition (clear ink), which is colorant-free or contains so small an amount of colorant that the purpose of its use is no longer coloring (e.g., 0.1% by mass or less).

### 1.1.3. Surfactant

The aqueous ink composition may contain a surfactant. A surfactant can be of any kind, but examples include acetylene glycol surfactants, polyoxyalkylene alkyl ether surfactants, fluorosurfactants, silicone surfactants, and amphoteric surfactants. Any surfactant of such types can be used, and a combination can also be used.

Examples of commercially available surfactants that can be used include Surfynol SE, Surfynol 61, Surfynol 104, Surfynol 420, Surfynol 82, Surfynol DF110D, Surfynol 104S, Surfynol 104PG50, Surfynol 420, Surfynol 82, Surfynol MD-20, Surfynol 485, OLFINE E1004, OLFINE E4300, OLFINE E1010, and OLFINE EXP4300 (trade names, acetylene glycol surfactants, Nissin Chemical Industry), NOIGEN ET-116B, NOIGEN DL-0415, NOIGEN ET-106A, NOIGEN DH-0300, NOIGEN YX-400, and NOIGEN EA-160 (trade names, polyoxyalkylene alkyl ether surfactants, DKS), Newcol 1006 and 1006-AL (trade names, polyoxyalkylene alkyl ether surfactants, Nippon Nyukazai Co., Ltd.), BYK-348 (trade name, a silicone surfactant, BYK Japan KK), EMULGEN 1108 (trade name, a polyoxyalkylene alkyl ether, Kao Corporation), KF-6011, KF-6013, KF-6004, KF-6020, KF-6043, KF-643, KF-640, KF-351A, KF-354L, KF-945, X-22-6191, X-22-4515, KF-6015, KF-6017, and KF-6038 (trade names, polysiloxane surfactants, Shin-Etsu Silicone), and L-720, L-7002, FZ-2123, FZ-2105, L-7604, FZ-2104, FZ-2116, and FZ-2120 (trade names, polysiloxane surfactants, Dow Corning Toray).

Examples of amphoteric surfactants include alkylpyridinium salts, alkyl amino acid salts, and alkyl dimethyl betaines. An amphoteric surfactant can be, for example, a betaine surfactant represented by formula (b-1) below.

(R)ₚ—N-[L-(COOM)_{q}]ᵣ (b-1)

(In formula (b-1), R represents a hydrogen atom or alkyl, aryl, or heterocyclic group. L represents a linking group with a valency of 2 or more. M represents a hydrogen atom, an alkali metal atom, an ammonium group, a protonated organic amine or nitrogen-containing heterocyclic group, or a quaternary ammonium ion group. When being a counterion for an ammonium ion that involves the N atom in formula (b-1), M represents a non-cationic group. q represents an integer of 1 or more, and r represents an integer of 1 or more and 4 or less. p represents an integer of 0 or more and 4 or less, and p+r is 3 or 4. When p+r is 4, the nitrogen atom N is a component of a quaternary amine. When p is 2 or more, the Rs may be the same or different. When q is 2 or more, the COOMs may be the same or different. When r is 2 or more, the L-(COOM)_{q}s may be the same or different.)

Preferably, the betaine surfactant represented by formula (b-1) above is a compound represented by formula (b-2).

(R¹)(R²)(R³)N⁺—X—COO⁻ (b-2)

(In formula (b-2), R¹ to R³ each independently represent a C1 to C20 alkyl group, and X represents a divalent linking group.)

Preferably, the compound represented by formula (b-2) above is the compound represented by formula (b-3) below (myristyl betaine or N-tetradecyl-N,N-dimethylglycine).

(n-C₁₄H₂₉)(CH₃)₂N⁺—CH₂—COO⁻ (b-3)

The surfactant content is preferably 0.01% by mass or more and 2.0% by mass or less, more preferably 0.05% by mass or more and 1.50% by mass or less, even more preferably 0.10% by mass or more and 1.20% by mass or less of the total mass of the aqueous ink composition. A surfactant content of 0.01% by mass or more helps, for example, improve ejection stability.

### 1.1.4. Organic Solvent

The aqueous ink composition may contain an organic solvent. Although optional, the use of an organic solvent is an easy way to combine quick drying and stable ejection. Water-soluble organic solvents are preferred.

A function of the organic solvent is to improve the wettability of the aqueous ink composition on a recording medium and to enhance the water retention of the aqueous ink composition. Examples of organic solvents include esters, alkylene glycol ethers, cyclic esters, nitrogen-containing solvents, and polyhydric alcohols. Examples of nitrogen-containing solvents include cyclic amides and acyclic amides. Examples of acyclic amides include alkoxyalkylamides.

Examples of esters include glycol monoacetates, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate, and glycol diesters, such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, and dipropylene glycol acetate propionate.

An alkylene glycol ether can be any monoether or diether of an alkylene glycol, preferably an alkyl ether. Specific examples include alkylene glycol monoalkyl ethers, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether, and alkylene glycol dialkyl ethers, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Examples of cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, ε-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone and compounds derived from such lactones by substituting hydrogen(s) in the methylene group next to the carbonyl group with a C1 to C4 alkyl group.

Examples of alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-d imethylpropionamide, 3-n-propoxy-N,N-diethylpropionamide, 3-n-propoxy-N,N-methylethylpropionamide, 3-isopropoxy-N,N-dimethylpropionamide, 3-isopropoxy-N,N-diethylpropionamide, 3-isopropoxy-N,N-methylethylpropionamide, 3-tert-butoxy-N,N-dimethylpropionamide, 3-tert-butoxy-N,N-diethylpropionamide, and 3-tert-butoxy-N,N-methylethylpropionamide.

Examples of cyclic amides include lactams, such as pyrrolidones including 2-pyrrolidone, 1-methyl-2-pyrrolidone, 1-ethyl-2-pyrrolidone, 1-propyl-2-pyrrolidone, and 1-butyl-2-pyrrolidone. These are preferred in that they help resin particles, described below, form film. 2-Pyrrolidone is particularly preferred.

It is also preferred to use an alkoxyalkylamide, which is a type of acyclic amide and is represented by formula (1) below.

R¹—O—CH₂CH₂—(C═O)—NR²R³ (1)

In formula (1) above, R¹ denotes a C1 to C4 alkyl group, and R² and R³ each independently denote a methyl or ethyl group. The “C1 to C4 alkyl group” can be a linear or branched alkyl group. To name a few, it can be a methyl, ethyl, n-propyl, isopropyl, n-butyl, sec-butyl, isobutyl, or tert-butyl group. One compound represented by formula (1) above may be used alone, or two or more may be used as a mixture.

Examples of polyhydric alcohols include 1,2-alkanediols (e.g., alkanediols such as ethylene glycol, propylene glycol (also known as propane-1,2-diol), triethylene glycol, 1,2-butanediol, 1,2-pentanediol, 1,2-hexanediol, 1,2-heptanediol, and 1,2-octanediol) and polyhydric alcohols other than 1,2-alkanediols (polyols) (e.g., diethylene glycol, dipropylene glycol, 1,3-propanediol, 1,3-butanediol (also known as 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylolpropane, and glycerol).

The aqueous ink composition may contain one such organic solvent as listed above alone or may contain two or more in combination. When the aqueous ink composition is made with organic solvent(s), the total percentage of organic solvents to the aqueous ink composition as a whole is 3.0% by mass or more and 30.0% by mass or less, preferably 5.0% by mass or more and 25.0% by mass or less, more preferably 10.0% by mass or more and 20.0% by mass or less.

### 1.1.5. Other Ingredients

Other ingredients that may be contained in the aqueous ink composition include pH-adjusting agents, fungicides/preservatives, chelating agents, antirusts, antimolds, antioxidants, antireductants, and drying agents.

Examples of pH-adjusting agents include urea compounds, amines, morpholines, piperazines, and aminoalcohols, such as alkanolamines. Examples of urea compounds include urea, ethylene urea, tetramethylurea, thiourea, and 1,3-dimethyl-2-imidazolidinone. Examples of amines include diethanolamine, triethanolamine, and triisopropanolamine. pH-adjusting agents help, for example, retard or accelerate the dissolution of impurities from materials forming the channel through which the ink flows, thereby helping adjust the detergency of the aqueous ink composition.

Examples of fungicides/preservatives include PROXEL CRL, PROXEL BDN, PROXEL GXL, PROXEL XL2, PROXEL IB, and PROXEL TN (all are trade names; Lonza). Fungicides/preservatives help control fungal and bacterial growth, thereby improving the storage of the aqueous ink composition.

Examples of chelating agents include ethylenediaminetetraacetic acid (EDTA) and the nitrilotriacetate, hexametaphosphate, pyrophosphate, and metaphosphate of ethylenediamine.

### 1.1.6. Angle of Contact of the Aqueous Ink Composition

Preferably, the aqueous ink composition comes into contact with an inner wall of the ink encasement at an angle of 40° or less, more preferably 35° or less. This improves the removal of air during the loading of the aqueous ink composition into the ink encasement. The likelihood is reduced that bubbles will be left between the ink composition and the ink encasement, helping prevent defective ejection caused by residual bubbles moving toward nozzles. This is advantageous particularly when the ink encasement is loaded with the aqueous ink composition for the first time. Ensuring such an angle of contact therefore leads to good initial loading.

The angle of contact can be measured by analyzing the aqueous ink composition on a sheet of the same material as the ink encasement using Kyowa Interface Science's PCA-1 dynamic surface tensiometer. Specifically, for example, a droplet of the aqueous ink composition is put on the sheet, and the angle of contact is measured 20 seconds later.

The angle of contact of the aqueous ink composition can be adjusted by, for example, changing at least one of the type(s), combination, and amount(s) of at least one of water, organic solvent(s), and surfactant(s). Alternatively, the angle of contact of the aqueous ink composition may be adjusted by selecting an appropriate material for the ink encasement.

### 1.1.7. Use of the Aqueous Ink Composition

This aqueous ink composition is for use with an ink jet recording apparatus that includes the aqueous ink composition, an ink encasement in which the aqueous ink composition is encased, a recording head that ejects the aqueous ink composition, and a carriage configured to move the recording head back and forth. The carriage carries the ink encasement, with the ink encasement integrated with the carriage. The ink encasement has an ink fill port that opens and shuts as a port through which the aqueous ink composition is loaded, and the maximum external length of the ink encasement in the direction parallel with the direction in which the carriage moves back and forth is 30.0 mm or less. The following describes an ink jet recording apparatus according to this embodiment.

### 1.2. Structure of the Ink Jet Recording Apparatus

An ink jet recording apparatus according to this embodiment includes an aqueous ink composition as described above. The following outlines its structure excluding the aqueous ink composition by taking an ink jet recording apparatus 1 as an example. The ink jet recording apparatus 1 includes an aqueous ink composition, an ink encasement 7 in which the aqueous ink composition is encased, a recording head 3 that ejects the aqueous ink composition, and a carriage 4 configured to move the recording head 3 back and forth. The carriage 4 carries the ink encasement 7, with the ink encasement 7 integrated with the carriage 4. The ink encasement 7 has an ink fill port 71 that opens and shuts as a port through which the aqueous ink composition is loaded. In the drawings referenced in the following description, the scale may vary from element to element so that each element is recognizable.

The ink jet recording apparatus according to this embodiment has an ink encasement 7 that is refilled with an aqueous ink composition through its ink fill port on an as-needed basis. When refilled, the ink encasement 7 contains some residual ink. An ink composition in such a refill-in-use ink encasement is not completely refreshed, for example as in a cartridge that is replaced as a whole. Rather, aged residues of the ink composition accumulate, occasionally accelerating chemical alteration of the composition. To be more specific, the colorant(s) can precipitate. The ink jet recording apparatus according to this embodiment, however, has a carriage 4 and an ink encasement 7 integrated with each other. As the carriage 4 moves back and forth, the ink composition in the ink encasement 7 is stirred. This limits the precipitation of the colorant(s) therein, thereby helping effectively reduce the mottling of recordings.

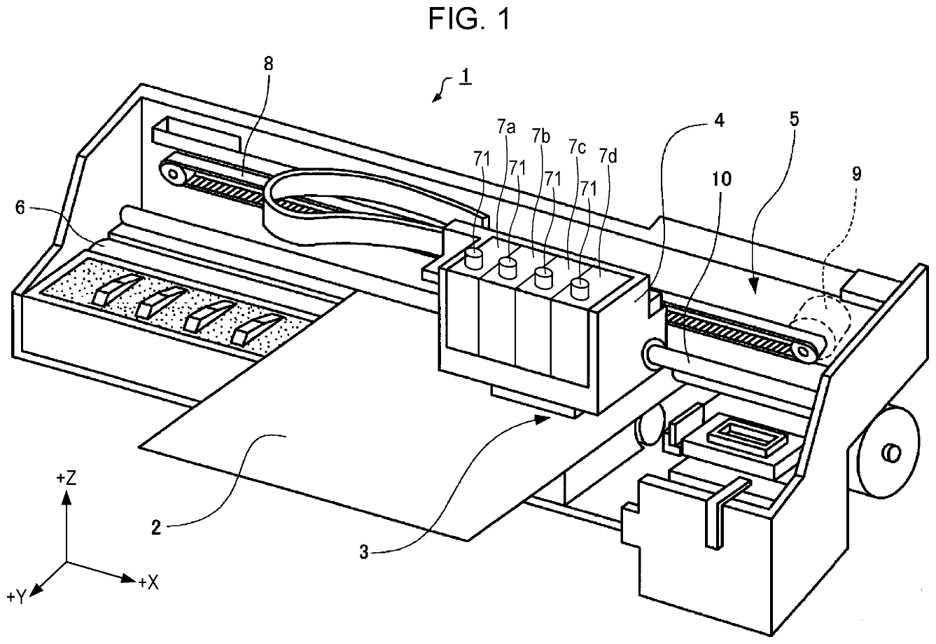

The recording head 3 is an aqueous-ink-composition ejector that ejects tiny droplets of the aqueous ink composition. Using this recording head 3, the ink jet recording apparatus 1 attaches droplets to a recording medium 2. FIG. 1 is an outline perspective diagram illustrating the ink jet recording apparatus 1.

As illustrated in FIG. 1, the ink jet recording apparatus 1 has a recording head 3, a carriage 4, a main scanning mechanism 5, a platen roller 6, and a control unit (not illustrated) that controls the overall operation of the ink jet recording apparatus 1. The carriage 4 carries the recording head 3 and ink encasements 7a, 7b, 7c, and 7d in which aqueous ink compositions to be supplied to the recording head 3 are contained. That is, the carriage 4 moves the recording head 3 back and forth and carries ink encasements 7a, 7b, 7c, and 7d, with the ink encasements 7a, 7b, 7c, and 7d integrated with the carriage 4. The illustrated ink encasements 7a, 7b, 7c, and 7d each represent an example of an ink encasement 7.

The ink encasements 7a, 7b, 7c, and 7d are immobilized and cannot be detached from the carriage 4 by the user. That is, the carriage 4 carries an ink encasement 7 integrated therewith. The integration between the carriage 4 and the ink encasement 7 may be achieved by producing the ink encasement 7 separately from the carriage 4 and screwing, gluing with an adhesive agent, or otherwise fastening it to the carriage 4, or may be achieved by monolithically forming the carriage 4 and the ink encasement 7. With the ink encasements 7a, 7b, 7c, and 7d immobilized on the carriage 4, the user can access their ink fill port 71, which opens and shuts, to fill, refill, etc., the ink encasements 7a, 7b, 7c, and 7d with aqueous ink compositions. The details of the ink encasement 7 will be discussed later herein.

The main scanning mechanism 5 has a timing belt 8 connected to the carriage 4, a motor 9 that drives the timing belt 8, and a guide shaft 10. The guide shaft 10 extends in the direction in which the carriage 4 moves, or in the main scanning direction, and serves as a support for the carriage 4. The carriage 4 is driven by the motor 9 via the timing belt 8 to move back and forth along the guide shaft 10. In this way, the main scanning mechanism 5 moves the carriage 4 back and forth in the main scanning direction.

The platen roller 6 transports a recording medium 2, on which a record is produced, in a sub-scanning direction perpendicular to the main scanning direction, or along the length of the recording medium 2. The recording medium 2 is therefore transported in the sub-scanning direction. The carriage 4 moves back and forth in the main scanning direction with the recording head 3 and ink encasements 7a, 7b, 7c, and 7d thereon, and the main scanning direction is substantially identical to the direction along the width of the recording medium 2. As a result, the recording head 3 moves in the main and sub-scanning directions relative to the recording medium 2.

The ink encasements 7a, 7b, 7c, and 7d are four independent ink encasements. The same or different aqueous ink compositions can be encased in the ink encasements 7a, 7b, 7c, and 7d. These ink encasements separately contain aqueous ink compositions, for example in the colors of black, cyan, magenta, and yellow, and can be used in any combination. The number of ink encasements does not need to be four as illustrated in FIG. 1. On the bottom of the ink encasements 7a, 7b, 7c, and 7d is a supply port (hidden in FIG. 1) through which the aqueous ink composition contained is supplied to the recording head 3. By virtue of integration with the carriage 4, the ink encasements 7a, 7b, 7c, and 7d, unlike cartridges, do not expose their supply port to the outside. This helps reduce contamination through the supply port, such as air entrainment.

The recording head 3 ejects aqueous ink compositions supplied from the ink encasements 7a, 7b, 7c, and 7d and attaches them to a recording medium 2 through multiple nozzles under the control of the control unit (not illustrated). On its surface facing the recording medium 2 to which the aqueous ink compositions are attached, the recording head 3 has multiple nozzles (hidden in FIG. 1) through which it ejects the aqueous ink compositions and attaches them to the recording medium 2. These multiple nozzles are lined up to form nozzle lines, and there are separate nozzle lines for aqueous ink compositions in different colors. Each aqueous ink composition is supplied from an ink encasement to the recording head 3 and ejected as droplets through the nozzles by the action of actuators (not illustrated) provided inside the recording head 3. The ejected droplets of aqueous ink compositions land on the recording medium 2, forming an image, text, a pattern, an expression of colors, etc., of the aqueous ink compositions on the recording medium 2.

The recording head 3 uses piezoelectric elements as driving actuators, but this is not the only possible mode of driving. For example, the actuators may be electromechanical transducers, which displace a diaphragm as an actuator using electrostatic attraction, or electrothermal transducers, which eject droplets of an aqueous ink composition using bubbles generated by heating.

In the X-Y-Z coordinate system illustrated in FIG. 1, the X direction is the direction in which the recording head 3 and ink encasements 7a, 7b, 7c, and 7d move (i.e., the direction parallel with the direction in which the carriage 4 moves back and forth) and at the same time is along the width of the ink jet recording apparatus 1. The Y direction represents the direction along the depth of the ink jet recording apparatus 1 (i.e., the direction in which the recording medium 2 moves), and the Z direction represents the direction along the height of the ink jet recording apparatus 1. In FIG. 1, the +Y direction is toward the front of the ink jet recording apparatus 1, whereas the −Y direction is toward the back or rear of the ink jet recording apparatus 1. In the front view of the ink jet recording apparatus 1, the direction toward the right is the +X direction, and that toward the left is the −X direction. The +Z direction is toward the top (including the upper portion, the top surface, etc.) of the ink jet recording apparatus 1, and the −Z direction is toward the bottom (including the lower portion, the bottom surface, etc.) of the ink jet recording apparatus 1.

### 1.3. Ink Encasement

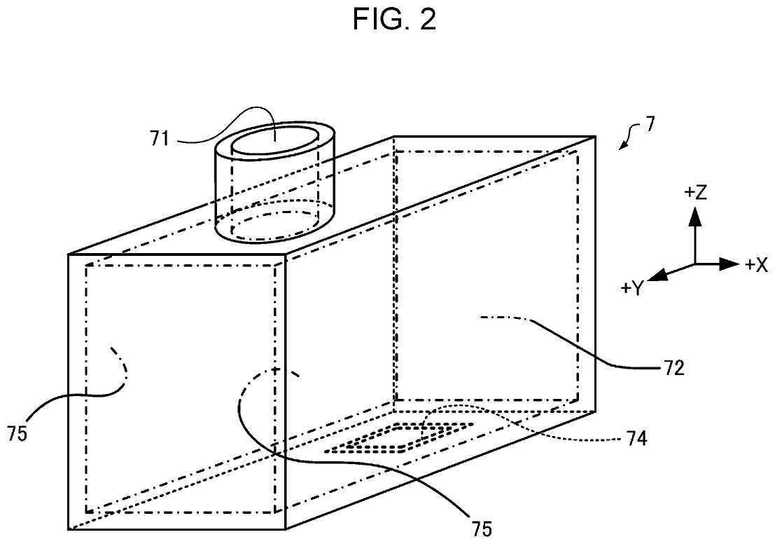

This ink jet recording apparatus 1 has four ink encasements, ink encasements 7a, 7b, 7c, and 7d, and all of them have an ink fill port 71 that opens and shuts as a port through which an aqueous ink composition is loaded. In the following, an ink encasement 7 that can be used as any of the ink encasements 7a, 7b, 7c, and 7d is described with reference to FIG. 2. FIG. 2 is a perspective diagram schematically illustrating the ink encasement 7. In the X-YZ coordinate system illustrated in FIG. 2, the X direction is the direction in which the recording head 3 and ink encasement 7 move (i.e., the direction in which the carriage 4 moves back and forth). The aqueous ink composition is encased in an encasing chamber 72. In FIG. 2, the encasing chamber 72 is the rectangular parallelepiped space indicated by dash-dot lines.

### 1.3.1. Shape and Other Details of the Ink Encasement

The ink encasement 7 has at least an ink fill port 71 that opens and shuts as a port through which an aqueous ink composition is loaded. In the example illustrated in FIG. 2, the ink encasement 7 has an ink fill port 71, an encasing chamber 72, and an ink discharge port 74.

The encasing chamber 72 encases an aqueous ink composition. The encasing chamber 72 has a substantially rectangular parallelepiped shape, defined by the encasement's frame. The walls that define the encasing chamber 72 are of, for example, a shaped plastic article or film. The encasing chamber 72 and the frame can be in any shape as long as the ink encasement 7 can encase and eject an aqueous ink composition and can be immobilized on the carriage 4. For example, the ink encasement 7 may have inside the encasing chamber 72 a component that reinforces the structural strength of its frame, such as ribs or a pillar.

As the carriage 4 moves, the ink encasement 7 thereon is rocked in the X direction.

The encasing chamber 72 communicates with the ink fill port 71 and the ink discharge port 74. The ink fill port 71 is an opening that communicates with the encasing chamber 72. The ink fill port 71 is above the encasing chamber 72 (up in the Z direction). The ink fill port 71 has a lid not illustrated. The lid opens and shuts and is manipulated, for example by the user, when the ink encasement 7 is refilled with the aqueous ink composition or for other needs.

The ink discharge port 74 is an opening that communicates with the encasing chamber 72. The ink discharge port 74 is below the encasing chamber 72 (down in the Z direction). The ink discharge port 74 is an opening through which the aqueous ink composition encased in the encasing chamber 72 is discharged toward the recording head 3. The ink discharge port 74 has a filter 80, which is described later herein.

The aqueous ink composition is introduced through the ink fill port 71 into the encasing chamber 72 and discharged through the ink discharge port 74. An aqueous ink composition introduced into the encasing chamber 72 accumulates in the lower portion (down in the Z direction) by the action of the force of gravity, with a gas in the upper portion (up in the Z direction). When an aqueous ink composition is ejected from the recording head 3 in a recording job performed using the ink jet recording apparatus 1, an appropriate volume, based on the volume that should be ejected, of the aqueous ink composition is discharged through the ink discharge port 74. The ink encasement 7 may have components like an opening or valve that regulates the pressure inside its encasing chamber 72 and/or a detector that detects the amount of aqueous ink composition inside.

### 1.3.2. Dimensions of the Ink Encasement

The ink encasement 7 is narrower in the X direction than in the Y and Z directions, and the X direction is identical to the direction in which the carriage 4 moves back and forth (main scanning direction). The ink jet recording apparatus 1 according to this embodiment has an ink encasement 7 whose maximum external length in the direction parallel with the direction in which the carriage 4 moves back and forth (main scanning direction) is 30.0 mm or less.

The maximum external length in this context refers to the maximum length in the ±X directions of the +Y projection of the ink encasement 7. In the illustrated example, the outer surface of the walls 75 of the ink encasement 7 perpendicular to the direction in which the carriage 4 moves is flat. These walls 75, however, may have a curved outer surface, or there may be projections and/or depressions in their outer surface. In such cases, too, the maximum external length has the same definition.

Preferably, the maximum external length of the ink encasement 7 in the main scanning direction is 25.0 mm or less for the upper limit. As for the lower limit, the maximum external length of the ink encasement 7 in the main scanning direction is preferably 10.0 mm or more, more preferably 15.0 mm or more.

When the ink encasement 7 has such a maximum external length in the main scanning direction, the aqueous ink composition in the encasing chamber 72 is efficiently stirred as the carriage 4 moves. This helps reduce mottling caused by precipitation, for example of a colorant. The aqueous ink composition, moreover, is not excessively stirred and therefore is unlikely to foam. Instability in continuous printing caused by bubbles is therefore limited.

Preferably, the minimum thickness of the walls 75 of the ink encasement 7 perpendicular to the direction in which the carriage 4 moves is 0.1 mm or more and 5.0 mm or less. More preferably, the minimum thickness of these walls 75 is 0.5 mm or more and 5.0 mm or less, even more preferably 1.0 mm or more and 3.00 mm or less, in particular 1.5 mm or more and 2.5 mm or less. When these walls 75 have such a thickness, the encasing chamber 72 is large enough that the aqueous ink composition therein is thoroughly stirred. The robustness of the ink encasement 7 is also sufficient.

The dimensions of the encasing chamber 72 of the ink encasement 7 are as follows. The maximum internal dimension of the encasing chamber 72 in the direction in which the carriage 4 moves back and forth is 29.8 mm or less, preferably 29.0 mm or less. The maximum internal dimension of the encasing chamber 72 in the direction in which the carriage 4 moves back and forth can be paraphrased as the maximum length in the ±X directions. That is, when an imaginary line parallel with the ±X directions is drawn through the ink encasement 7, this maximum internal dimension is the maximum length of the line inside the encasing chamber 72. As for the lower limit, the maximum internal dimension of the encasing chamber 72 in the direction in which the carriage 4 moves back and forth is 10.0 mm or more, preferably 15.0 mm or more. The same is true even when the encasing chamber 72 has ribs, a pillar, or any similar component inside.

When the encasing chamber 72 has such a maximum internal dimension in the main scanning direction, the aqueous ink composition therein is efficiently stirred as the carriage 4 moves. The stirring of the aqueous ink composition, moreover, is to an extent that the ink composition is unlikely to foam.

The capacity of the encasing chamber 72 is greater than that of ordinary ink cartridges. For example, the encasing chamber 72 has a capacity of 10 mL or more and 100 mL or less, preferably 20 mL or more and 80 mL or less, more preferably 30 mL or more and 50 mL or less. The capacity of the encasing chamber 72 can be adjusted by changing dimension(s) of the chamber 72, for example in the Z direction and/or Y direction, with the dimensions in the direction in which the carriage 4 moves back and forth set as described above.

### 1.3.3. Material for the Ink Encasement

The material for the ink encasement 7 can be, for example, polypropylene, polyethylene, ABS, or a blend or copolymer thereof. The angle of contact of the aqueous ink composition with an inner wall of the ink encasement 7 may be adjusted by changing the material for the ink encasement 7. The ink encasement 7, or at least its inner walls, may be surface-treated to be hydrophilic or water-repellent, and such a treatment may be used to adjust the angle of contact.

### 1.3.4. Gas-to-Liquid Ratio by Volume Inside the Ink Encasement

The ink encasement encases an aqueous ink composition, and there is a preferred range for the amount of ink composition encased. That is, when the gas-to-liquid ratio by volume (gas/liquid) inside the ink encasement is 2/17 or more, preferably 3/16 or more, the encased aqueous ink composition is rocked and stirred with great efficiency when the carriage moves during main scans. The “liquid” is the aqueous ink composition, and the “gas” is the air or volatile components in a closed ink encasement. When the proportion of the ink composition is too small, however, the rocking and stirring process is not very efficient. The gas-to-liquid ratio by volume (gas/liquid) is therefore 18/1 or less, preferably 15/4 or less.

### 1.3.5. Multiple Ink Encasements

As stated, the ink jet recording apparatus according to this embodiment may have multiple ink encasements. When it does, each of the multiple ink encasements can contain an aqueous ink composition that contains a disperse colorant or an aqueous ink composition that contains a water-soluble dye. One ink jet recording apparatus, therefore, may carry multiple ink encasements only for aqueous ink compositions containing disperse colorants or may carry multiple ink encasements only for aqueous ink compositions containing water-soluble dyes. Alternatively, the ink jet recording apparatus may carry an ink encasement for an aqueous ink composition that contains a disperse colorant and another for an aqueous ink composition that contains a water-soluble dye.

The ink jet recording apparatus according to this embodiment helps effectively prevent the mottling of recordings caused by precipitation, for example of a colorant, and limit instability in continuous printing caused by bubbles, but on the other hand suffers a limited ink composition capacity because of the restriction on the maximum external length of the ink encasement. The use of multiple ink encasements is a way to increase the total ink capacity while making the ink jet recording apparatus superior in the prevention of mottling and stability in continuous printing, too.

When the carriage of the ink jet recording apparatus according to this embodiment carries multiple ink encasements, the recording head may eject the aqueous ink compositions encased in the ink encasements.

### 2. INK JET RECORDING METHOD

An ink jet recording method according to this embodiment is a recording method in which an ink jet recording apparatus is used that includes an aqueous ink composition, an ink encasement in which the aqueous ink composition is encased, a recording head that ejects the aqueous ink composition, and a carriage configured to move the recording head back and forth. The carriage carries the ink encasement, with the ink encasement integrated with the carriage. The ink encasement has an ink fill port that opens and shuts as a port through which the aqueous ink composition is loaded, and the maximum external length of the ink encasement in the direction parallel with the direction in which the carriage moves back and forth is 30.0 mm or less. The method includes ejecting the aqueous ink composition from the recording head to attach the aqueous ink composition to a recording medium.

The recording medium can be of any kind. It may have a recording surface that absorbs the aqueous ink composition or may have no such recording surface. Any kind of recording medium can therefore be used. Examples include paper, film, cloth, metal, glass, and polymers.

### 3. EXAMPLES AND COMPARATIVE EXAMPLES

The following describes an aspect of the present disclosure in detail by providing examples, but no aspect of the disclosure is limited to these Examples. In the following, “parts” and “%” are by mass unless stated otherwise. In Table 1, the numerical values are in the unit of % by mass, and the amounts of colorants are on a solids basis.

### 3.1. Preparation of Aqueous Ink Compositions

Table 1 summarizes the formulae of the aqueous ink compositions of Examples and Comparative Examples. Each aqueous ink composition was prepared by mixing the ingredients specified in Table 1, stirring them for 30 minutes or longer, and filtering the mixture. The mixing of the ingredients was by adding the materials one by one to a container equipped with a mechanical stirrer and then stirring and mixing the materials. The resulting mixtures were filtered to complete the aqueous ink compositions of Inks 1 to 6. In Table 1, the numerical values representing the amounts of ingredients are in the unit of % by mass.

TABLE 1

| Ingredient name | Ink 1 | Ink 2 | Ink 3 | Ink 4 | Ink 5 | Ink 6 |
|---|---|---|---|---|---|---|
| BAYSCRIPT | 4.00 | 4.00 | 4.00 | — | — | — |
| Cyan BA | | | | | | |
| (dye solids | | | | | | |
| content) | | | | | | |
| Self-dispersible | — | — | — | 6.00 | 6.00 | 6.00 |
| pigment | | | | | | |
| (pigment solids | | | | | | |
| content) | | | | | | |
| Glycerol | 10.00 | 10.00 | 10.00 | 10.00 | 10.00 | 10.00 |
| Triethylene | 12.00 | 12.00 | 12.00 | 2.00 | 2.00 | 2.00 |
| glycol | | | | | | |
| 2-Pyrrolidone | — | — | — | 5.00 | 5.00 | 5.00 |
| TEGmBE | 10.00 | 10.00 | 10.00 | 4.00 | 4.00 | 4.00 |
| 1,2-Hexanediol | — | — | — | 2.50 | 2.50 | 2.50 |
| OLFINE | 0.10 | 0.10 | 0.10 | — | — | — |
| EXP4300 | | | | | | |
| OLFINE E1010 | — | — | — | 1.00 | 1.00 | 1.00 |
| Surfynol | 0.20 | 0.05 | 0.00 | 0.20 | 0.05 | 0.00 |
| 104PG50 | | | | | | |
| Triethanolamine | 0.30 | 0.30 | 0.30 | 0.50 | 0.50 | 0.50 |
| Purified water | 63.40 | 63.55 | 63.60 | 68.80 | 68.95 | 69.00 |
| Total | 100.00 | 100.00 | 100.00 | 100.00 | 100.00 | 100.00 |

The abbreviated names of ingredients in Table 1 represent the following materials.

BAYSCRIPT Cyan BA: Lanxess

Self-dispersible pigment: Carbon black (Orient Chemical Industries Co., Ltd.'s CW-1)

TEGmBE: Triethylene glycol monobutyl ether (reagent grade, Tokyo Chemical Industry)

OLFINE EXP4300: An acetylene glycol surfactant, Nissin Chemical Industry

OLFINE E1010: An acetylene glycol surfactant, Nissin Chemical Industry

Surfynol 104PG50: An acetylene glycol surfactant, Nissin Chemical Industry

### 3.2. Testing

Ink jet recording apparatuses of Examples and Comparative Examples were tested as follows. The parameters presented in Tables 2 and 3 were used.

### 3.2.1. Printing

The recording apparatuses of Examples and Comparative Examples were versions of Seiko Epson Corporation's “PX-S170T” modified to the configurations specified in Tables 2 and 3. The ink encasement had 0.5-mm thick walls perpendicular to the direction parallel with the direction in which the carriage was to move back and forth. In Tables 2 and 3, the “external width” represents the maximum external length of the ink encasement in the direction parallel with the direction in which the carriage was to move back and forth. Although not presented in the tables, the maximum internal dimension of the encasing chamber was the maximum external length of the ink encasement minus 1.0 mm (combined thickness of two walls). The “gas-liquid ratio” represents the gas-to-liquid ratio by volume (gas/liquid) inside the ink encasement.

In the container position row in Tables 2 and 3, “ON” refers to “on carriage,” which means the container (ink encasement) was immobilized on a carriage, or mounted on a carriage in such a manner that the user could not remove it, as in the above embodiment. “OFF” refers to “off carriage,” which means the ink encasement was not mounted on a carriage. In this case the container (ink encasement) was attached to the body of the recording apparatus, and the aqueous ink composition therein was supplied to a recording head on a carriage through a tube. The container was of polypropylene in all Examples and Comparative Examples.

### 3.2.2. Measurement of the Angle of Contact

The angle of contact of the aqueous ink composition with an inner wall of the container was measured using Kyowa Interface Science's PCA-1 dynamic surface tensiometer. A droplet of the ink composition was put on a polypropylene sheet, and the angle of contact was measured 20 seconds later. The results are presented in Tables 2 and 3.

### 3.2.3. Mottling

First, the pattern set forth in JEITA CP-3901 standard was printed on a recording medium (Epson photo paper, Seiko Epson Corporation). The print results were defined as initial image quality. Then the ink encasement was removed (at the manufacturer), placed in a centrifuge (himac CF9RX, Koki Holdings) to apply the centrifugal force toward the bottom of the ink encasement, and spun at 430 rpm for 360 hours. The centrifuged ink encasement was returned to the printer, without stirring the components of the aqueous ink composition. Then the JEITA CP-3901 pattern was printed on 10 sheets of the recording medium (Epson photo paper, Seiko Epson Corporation).

The printed patterns were analyzed using i1 color profiler (X-rite). The color difference ΔE was determined as the change in color density from before to after centrifugation, and mottling was graded according to the criteria below. The results are presented in Tables 2 and 3. The criteria varied according to the type of colorant in the ink as follows.

### Dye

A: The color difference ΔE is 1 or less.

B: The color difference ΔE is more than 1 and 2 or less.

C: The color difference ΔE is more than 2.

### Pigment

A: The color difference ΔE is 4 or less.

B: The color difference ΔE is more than 4 and 10 or less.

C: The color difference ΔE is more than 10.

### 3.2.4. Stability in Continuous Printing

After the initial loading test (described below), the printer was left for 2 days to allow air bubbles in the printer's ink channel to dissipate. Then the printer's preset powerful cleaning function, intended to avoid poor initial loading, was run. The inventors deemed that any air bubble remaining in the ink channel would be removed by this powerful cleaning process. Then the set of five test pages defined in ISO 24712 was printed on 1000 sheets of A4 ordinary printing paper. Stability in continuous printing was graded according to the following criteria based on the total number of non-ejecting nozzles during the printing on 1000 sheets. The results are presented in Tables 2 and 3.

A: Three or less

B: Four or more and less than ten

C: Ten or more

### 3.2.5. Initial Loading

Each of the aqueous ink compositions was loaded into an empty ink encasement of an unused printer. Using this printer, a solid image was printed on 100 sheets of A4 ordinary printing paper. Any air bubble in the printer's ink channel results in a sign of misfiring or misregistration on an image. Thus the number of misfiring nozzles and misregistrations during the printing on 100 sheets was totaled up, and initial loading was graded according to the following criteria based on it. The results are presented in Tables 2 and 3. A misfiring nozzle refers to a void in a printed nozzle check pattern that is produced when a nozzle fails to eject ink, and a misregistration refers to an out-of-place line in a printed nozzle check pattern that is produced by a curved flight of ink.

A: Zero

B: One or more and five or less

C: Six or more

TABLE 2

| | | | | | | | | | | | | | Comparative | |
|---|---|---|---|---|---|---|---|---|---|---|---|---|---|---|
| | | Examples | | | | | | | | | | | Examples | |
| | | 1 | 2 | 3 | 4 | 5 | 6 | 7 | 8 | 9 | 10 | 11 | 1 | 2 |
| Container | Position | ON | ON | ON | ON | ON | ON | ON | ON | ON | ON | ON | OFF | ON |
| | External | 5.0 | 10.0 | 20.0 | 30.0 | 20.0 | 20.0 | 20.0 | 20.0 | 20.0 | 20.0 | 20.0 | 20.0 | 35.0 |
| | width (mm) | | | | | | | | | | | | | |
| | Gas-liquid | 0.19 | 0.19 | 0.19 | 0.19 | 0.12 | 0.73 | 1.38 | 3.75 | 5.33 | 0.19 | 0.19 | 0.19 | 0.19 |
| | ratio | | | | | | | | | | | | | |
| | Ink No. | 1 | 1 | 1 | 1 | 1 | 1 | 1 | 1 | 1 | 2 | 3 | 1 | 1 |
| | Angle of | 35° | 35° | 35° | 35° | 35° | 35° | 35° | 35° | 35° | 40° | 45° | 35° | 35° |
| | contact | | | | | | | | | | | | | |
| Type of colorant in the | | Dye | Dye | Dye | Dye | Dye | Dye | Dye | Dye | Dye | Dye | Dye | Dye | Dye |
| ink | | | | | | | | | | | | | | |
| Test results | Mottling | B | A | A | A | B | A | A | A | A | A | A | C | A |
| | Stability in | A | A | A | A | A | A | A | A | B | A | A | A | C |
| | continuous | | | | | | | | | | | | | |
| | printing | | | | | | | | | | | | | |
| | Initial | A | A | A | A | A | A | A | A | A | A | B | A | A |
| | loading | | | | | | | | | | | | | |

Table 3

| | | Examples | | | | | | | |
|---|---|---|---|---|---|---|---|---|---|
| | | 12 | 13 | 14 | 15 | 16 | 17 | 18 | 19 |
| Container | Position | ON | ON | ON | ON | ON | ON | ON | ON |
| | External | | | | | | | | |
| | width (mm) | 5.0 | 10.0 | 20.0 | 30.0 | 20.0 | 20.0 | 20.0 | 20.0 |
| | Gas-liquid | 0.19 | 0.19 | 0.19 | 0.19 | 0.12 | 0.73 | 1.38 | 3.75 |
| | ratio | | | | | | | | |
| | Ink No. | 4 | 4 | 4 | 4 | 4 | 4 | 4 | 4 |
| | Angle of | | | | | | | | |
| | contact | 35° | 35° | 35° | 35° | 35° | 35° | 35° | 35° |
| Type of colorant in the | | Pigment | Pigment | Pigment | Pigment | Pigment | Pigment | Pigment | Pigment |
| ink | | | | | | | | | |
| Test | Mottling | B | A | A | A | B | A | A | A |
| results | Stability in | A | A | A | A | A | A | A | A |
| | continuous | | | | | | | | |
| | printing | | | | | | | | |
| | Initial | A | A | A | A | A | A | A | A |
| | loading | | | | | | | | |
| | | | | | | | | Comparative | |
| | | | | | Examples | | | Examples | |
| | | | | | 20 | 21 | 22 | 3 | 4 |
| | | | Container | Position | ON | ON | ON | OFF | ON |
| | | | | External | | | | | |
| | | | | width (mm) | 20.0 | 20.0 | 20.0 | 20.0 | 35.0 |
| | | | | Gas-liquid | 5.33 | 0.19 | 0.19 | 0.19 | 0.19 |
| | | | | ratio | | | | | |
| | | | | Ink No. | 4 | 5 | 6 | 4 | 4 |
| | | | | Angle of | | | | | |
| | | | | contact | 35° | 40° | 45° | 35° | 35° |
| | | | Type of colorant in the | | Pigment | Pigmentt | Pigmen | Pigment | Pigment |
| | | | ink | | | | | | |
| | | | Test | Mottling | A | A | A | C | A |
| | | | results | Stability in | B | A | A | A | C |
| | | | | continuous | | | | | |
| | | | | printing | | | | | |
| | | | | Initial | A | A | B | A | A |
| | | | | loading | | | | | |

### 3.3. Test Results

The Examples were ink jet recording apparatuses that included an aqueous ink composition, an ink encasement in which the aqueous ink composition was encased, a recording head that was to eject the aqueous ink composition, and a carriage configured to move the ink encasement and the recording head back and forth. The carriage carried the ink encasement, with the ink encasement integrated with the carriage. The ink encasement had an ink fill port that opens and shuts as a port through which the aqueous ink composition was to be loaded, and the maximum external length of the ink encasement in the direction parallel with the direction in which the carriage was to move back and forth was 30.0 mm or less. As shown in Tables 2 and 3, in the Examples, mottling was effectively prevented, and stable continuous printing was achieved at the same time. It should be noted that in a dye ink in which a dye is dissolved, the components are less likely to precipitate than in a dispersion system, such as a pigment ink. A solution system, however, also varies in concentration from point to point, and this causes mottling in printing with a dye ink.

The present disclosure is not limited to the above embodiments, and many variations are possible. For example, the present disclosure embraces configurations substantially identical to those described in the embodiments (e.g., configurations identical in function, methodology, and results to or having the same goal and offering the same advantages as the described ones). The present disclosure also includes configurations created by changing any nonessential part of those described in the above embodiments. Furthermore, the present disclosure encompasses configurations identical in operation and effect to or capable of fulfilling the same purposes as those described in the above embodiments. Configurations obtained by adding any known technology to those described in the embodiments are also part of the present disclosure.

What is claimed is:

1. An ink jet recording apparatus comprising:
at least one aqueous ink composition;
at least one ink encasement in which the aqueous ink composition is encased;
a recording head that ejects the aqueous ink composition; and
a carriage configured to move the ink encasement and the recording head back and forth, wherein:
the carriage carries the ink encasement, with the ink encasement integrated with the carriage;
the ink encasement having an ink fill port that opens and shuts as a port through which the aqueous ink composition is loaded; and
a maximum external length of the ink encasement in a direction parallel with a direction in which the carriage moves back and forth is 30.0 mm or less.

2. The ink jet recording apparatus according to claim 1, wherein
a minimum thickness of walls of the ink encasement perpendicular to the direction parallel with the direction in which the carriage moves back and forth is 0.1 mm or more and 5.0 mm or less.

3. The ink jet recording apparatus according to claim 1, wherein
the maximum external length of the ink encasement in the direction parallel with the direction in which the carriage moves back and forth is 10.0 mm or more.

4. The ink jet recording apparatus according to claim 1, wherein
a gas-to-liquid ratio by volume, gas/liquid, inside the ink encasement is 3/16 or more.

5. The ink jet recording apparatus according to claim 1, wherein
a gas-to-liquid ratio by volume, gas/liquid, inside the ink encasement is 16/3 or less.

6. The ink jet recording apparatus according to claim 1, wherein
an angle of contact of the aqueous ink composition with an inner wall of the ink encasement is 40° or less.

7. The ink jet recording apparatus according to claim 1, wherein
the aqueous ink composition contains a dye or pigment.

8. The ink jet recording apparatus according to claim 1, wherein:
the at least one ink encasement carried on the carriage is a plurality of ink encasements; and
the recording head ejects each of the ink compositions encased in the ink encasements.

9. An ink jet recording method in which an ink jet recording apparatus is used that includes:
an aqueous ink composition;
an ink encasement in which the aqueous ink composition is encased;
a recording head that ejects the aqueous ink composition; and
a carriage configured to move the recording head back and forth,
the carriage carrying the ink encasement, with the ink encasement integrated with the carriage,
the ink encasement having an ink fill port that opens and shuts as a port through which the aqueous ink composition is loaded, and
a maximum external length of the ink encasement in a direction parallel with a direction in which the carriage moves back and forth being 30.0 mm or less,
the method comprising ejecting the aqueous ink composition from the recording head to attach the aqueous ink composition to a recording medium.
